(19) United States
(12) Patent Application Publication
(10) Pub. No.: US 2008/0144538 A1
(43) Pub. Date: Jun. 19, 2008

(54) Selling and Distributing Digital Content

(75) Inventor: Carl Johan Grandinson, Stockholm (SE)

Correspondence Address: GREENBERG TRAURIG, LLP, 1750 TYSONS BOULEVARD, 12TH FLOOR, MCLEAN, VA, 22102, US

(73) Assignee: Goldcup M 2187 AB, Stockholm (SE)

(21) Appl. No.: 11/765,066

(22) Filed: Jun. 19, 2007

Related U.S. Application Data
(60) Provisional application No. 60/870,051, filed on Dec. 14, 2006.

(51) Int. Cl. H04L 12/16

(52) U.S. Cl. 370/270

(57) ABSTRACT

A method for distributing digital content over a computer network, where a first user contacts a host computer and purchases the right to download the digital content. The present invention teaches that BitTorrent is used for downloading the digital content through other users connected to the network. Any other user that is used by the first user in the process of downloading the digital content is entitled to remuneration, and the first user is entitled to remuneration if any other user uses the first user in the process of downloading the digital content.

This application claims priority from Provisional U.S. Patent Application Ser. No. 60/870,051, filed Dec. 14, 2006, which is hereby incorporated by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The instant disclosure relates to a method for distributing digital content over a computer network, where a first user contacts a host computer and purchases the right to download the digital content.

### BACKGROUND

It is known to buy and sell digital content, such as music, film, pictures, games and computer software, over a wide area network such as the Internet. The distribution of digital content is done over the network, and as more and more users have network access, the Internet has become a very powerful way to reach the customers of digital content. Distribution of the content can be done by sending the content on a CD or DVD by ordinary mail, but a more natural way of distributing digital content is of course over the network, from the host computer to the user. However, in the latter case, bandwidth can be a problem since the file size of the digital content often is very large and the quality of the content is often sensitive when it comes to compression, it is hard to compress and decompress with a maintained content quality.

It is also known that it is very easy to share digital content over a network, where it is very hard for the rightful owners of the content to control the sharing of their content.

Many different kinds of digital locks are used in order to only allow users that have paid for the content to open and use the content. However, these kinds of locks are often cracked by users so the illegal sharing of files can continue even with content that is protected by digital locks.

One way of sharing files, legally or illegally, is the so called BitTorrent technology. Through BitTorrent the digital content is available, as one file or divided into several smaller files, through other users connected to the network. The users have a so called BitTorrent client running on the computer unit of the users, and a host computer contains a tracker that coordinates a file distribution among different clients connected to the network. A user can then download a torrent file pertaining to a certain digital content from the host computer; this torrent file contains meta data relating to how the digital content is divided into parts and how to get hold on information on other clients. This user opens the torrent file with a BitTorrent client, which connects to the tracker, and the tracker responds with a list of other clients currently sharing the file or files. The user client can then connect to one or several other clients and download the file or files.

The BitTorrent technology is a problem for owners of digital content since it is a very powerful tool to easily share large amounts of digital content in an illegal way.

### SUMMARY

Accordingly, the instant disclosure is directed toward methods of selling and distributing digital content that substantially obviates one or more of the problems due to limitations and disadvantages of the related art.

Additional features and advantages of the invention will be set forth in the description which follows, and in part will be apparent from this disclosure, or may be learned by practice of the invention. The objectives and other advantages of the invention will be realized and attained by the structure particularly pointed out in this written description, including any claims contained herein and the appended drawings.

It is a problem to distribute digital content from a central source to different users. This requires an enormous bandwidth and great computer power. Having a lot of digital content available for sale also requires vast storage areas, where the storage area limits the supply of digital content or the quality of the digital content. The requirements of bandwidth, computer power and storage are all expensive requirements on the central source or host computer.

Another problem with the sharing of digital content over a wide area network is the illegal sharing of the content, where the rightful owners of the content do not get paid for the use of their content. The content may also be distributed in very low and poor quality, and sometimes the content can be tampered with, modified or degraded. It is thus a problem for the owner of the content to have control of how the content is used and distributed over a wide area network such as the Internet.

With the purpose of solving one or more of the above indicated problems, and from the standpoint of a method for distributing digital content over a computer network, where a first user contacts a host computer and purchases the right to download the digital content, the present invention teaches that BitTorrent is used for downloading the digital content through other users connected to the network, thus distributing the bandwidth usage, computing and storage of the digital content. In order to give the different users an incentive not to distribute the content illegally it is proposed that any other user that is used by the first user in the process of downloading the digital content is entitled to remuneration for sharing the file according to the invention. The first user is also entitled to remuneration if any other user uses the first user in the process of downloading the digital content. The remuneration is calculated and administrated by the host computer.

The present invention teaches that a percentage of the purchase price is allocated for distribution and paid in remuneration. It is also possible to let the download of the digital content be free, and to allocate an amount for distribution costs paid out in remuneration.

The remuneration to a user can be based on the amount of data shared by the user, and it can also be based on what kind of digital content that is shared by the user.

The advantages of a method according to the present invention are that the distribution of bandwidth usage, computing power and storage leads to a virtually limitless distribution capacity and catalogue size. The invention will also result in the maintenance of the high quality of the digital content.

The payment and remuneration method is the incentive to the different users not to share the content illegally, since spreading the content in other channels would threaten their potential to earn money within the remuneration network, as well as this would be an illegal act. The users will stay in the network to profit by sharing content, thereby ensuring the availability of all content.

The content owners, or copyright holders, will be satisfied being able to sell their material in a safe way over the network and in knowing that their material will be presented in its intended fashion.

It is to be understood that both the foregoing general description and the following detailed description are exemplary and explanatory and are intended to provide further explanation of the disclosed toward methods of selling and distributing digital content.

### BRIEF DESCRIPTION OF THE DRAWINGS

The accompanying drawings, which are included to provide a further understanding of the disclosed toward methods of selling and distributing digital content and are incorporated in and constitute a part of this specification, illustrate various embodiments and, together with the description, serve to explain the principles of at least one embodiment of the disclosed toward methods of selling and distributing digital content.

In the drawings:

FIG. 1 is a is a schematic and simplified illustration of an inventive method for selling and distributing digital content.

### DETAILED DESCRIPTION

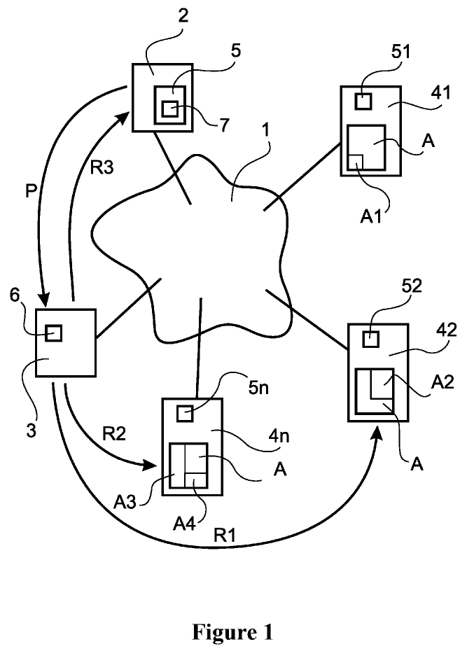

The present invention will now be described with reference to FIG. 1 showing a method for distributing digital content A over a computer network 1, where a first user 2 contacts a host computer 3 and purchases the right to download the digital content A, that is the first user 2 pays P the owner of the host computer 3 for the digital content A.

The present invention proposes that BitTorrent is used for downloading the digital content A through other users 41, 42, . . . , 4n connected to the network 1.

In the figure, the first user 2 uses the two other users 42, 4n in the process of downloading the digital content A, where a part of the content A2 is found with one other user 42 and another parts of the content A3 and A4 is found with another other user 4n. The other users 42, 4n that has been used by the first user 2 is entitled to remuneration R1, R2 from the owner of the host computer 3. The first user 2 is also entitled to remuneration if any other user uses the first user 2 in the process of downloading the digital content A.

The remuneration R1, R2, R3 is calculated and administrated by the host computer 3, and the present invention proposes that a percentage of the purchase price P is allocated for distribution and paid in remuneration R1, R2.

It is also possible that a content owner wants to distribute digital content for free, such as a preview of a film or a single piece of music from a larger collection of music, and that the content owner even is willing to remunerate users that share the content with other users, in which case it can be free to download the digital content A, in other words, the purchase price is nothing, and in which case a set amount can be allocated for distribution and paid in remuneration R1, R2, R3.

The remuneration R1, R2, R3 to a user 2, 41, 42, . . . , 4n can be based on the amount of data shared by said user, or it can be based on what kind of digital content that is shared by said user. More popular music may for instance give a larger remuneration than less popular music.

We will now describe in some detail how the BitTorrent technology is used in relation to the present invention. The digital content A can be available, as one file A or divided into several smaller files A1, A2, A3, A4, through other users 41, 42, . . . , 4n connected to the network. A user may have all of the file A or only a part of the file A1 depending on that this user may still be in the process of downloading the file A and has yet only downloaded a part of the file A1.

The other users 41, 42, . . . , 4n have other BitTorrent clients 51, 52, . . . , 5n running on their computer units, and the host computer 3 contains a tracker 6 that coordinates file distribution among different other clients 41, 42, . . . , 4n connected to the network 1. The user 2 downloads a torrent file 7 pertaining to the digital content A from the host computer 3. This torrent file 7 contains meta data relating to how the digital content A is divided into parts A1, A2, A3, A4 and how to get hold on information on the other clients 51, 52, . . . , 5n.

The user 2 opens the torrent file 7 with a user BitTorrent client 5, which connects to the tracker 6. The tracker 6 responds with a list of other clients 41, 42, . . . , 4n currently sharing the file A or files A1, A2, A3, A4, and the user client 2 connects to one or several other clients 42, 4n and downloads the file or files.

The user client 2 starts sharing a piece of the file or content to other clients as soon as a first piece of the file A is downloaded.

The present invention does not describe how the economical transaction between the different parties acting in the inventive method is performed. It will be understood that this can be performed in many different ways and that the present invention is not limited to any way of performing economical transactions.

While detailed and specific embodiments of the methods of selling and distributing digital content have been described herein, it will be apparent to those skilled in the art that various changes and modifications can be made therein without departing from the spirit and scope of the methods of selling and distributing digital content. Thus, it is intended that the present disclosure cover these modifications and variations provided they come within the scope of any appended claims and/or their equivalents.

What is claimed is:

1. A method for distributing digital content over a computer network, where a first user contacts a host computer and purchases the right to download said digital content, characterised, in that BitTorrent is used for downloading said digital content through other users connected to said network, that any other user that is used by said first user in the process of downloading said digital content is entitled to remuneration, and that said first user is entitled to remuneration if any other user uses said first user in the process of downloading said digital content.

2. The method according to claim 1, characterised in, that said remuneration is calculated and administrated by said host computer.

3. The method according to claim 1, characterised in, that a percentage of the purchase price is allocated for distribution and paid in remuneration.

4. The method according to claim 1, characterised in, that it is free to download said digital content, and that a set amount is allocated for distribution and paid in remuneration.

5. The method according to claim 1, characterised in, that the remuneration to a user is based on the amount of data shared by said user.

6. The method according to claim 1, characterised in, that the remuneration to a user is based on what kind of digital content that is shared by said user.

7. The method according to claim 5, characterised in, that the remuneration to a user is based on what kind of digital content that is shared by said user.

8. The method according to claim 1, characterised in, that said digital content is available, as one file or divided into several smaller files, through other users connected to said network and through other BitTorrent clients running on computer units of said other users, that said host computer contains a tracker that coordinates file distribution among different other clients connected to said network, that said user downloads a torrent file pertaining to said digital content from said host computer, said torrent file containing meta data relating to how said digital content is divided into parts and how to get hold on information on said other clients, that said user opens said torrent file with a user BitTorrent client, that said user client connects to said tracker, that said tracker responds with a list of other clients currently sharing said file or files, and that said user client connects to one or several other clients and downloads said file or files.

9. The method according to claim 8, characterised in, that, as soon as a first piece of said file is downloaded, said user client starts sharing said piece to other clients.
